(19) United States
(12) Patent Application Publication
(10) Pub. No.: US 2022/0263181 A1
(43) Pub. Date: Aug. 18, 2022

(54) EXPANDABLE BATTERY MODULE

(71) Applicant: EMATRIX ENERGY SYSTEMS, INC., Auburn Hills, MI (US)

(72) Inventor: Idan David Kovent, Huntington Woods, MI (US)

(21) Appl. No.: 17/177,326

(22) Filed: Feb. 17, 2021

(51) Int. Cl. H01M 50/258; H01M 10/6556; H01M 50/213; H01M 50/502; H01M 10/613

(52) U.S. Cl. CPC H01M 50/258; H01M 10/6556; H01M 10/613; H01M 50/502; H01M 50/213

(57) ABSTRACT

A battery module comprising sub-module components, or bricks, that facilitate efficient assembly utilizing common hand tools and provide integrated cooling features for increased battery configurability and performance.

### CROSS REFERENCE TO RELATED APPLICATION

This U.S. patent application is a continuation-in-part to U.S. Non-Provisional application Ser. No. 16/202,620 filed on Nov. 28, 2018, which is a continuation to U.S. Non-Provisional application Ser. No. 15/016,359 filed Feb. 5, 2016, the disclosure of which is considered part of the disclosure of this application and is hereby incorporated by reference in its entirety.

### FIELD OF THE INVENTION

This invention relates generally to an expandable battery module, specifically having physical features that facilitate physical and electrical connectivity.

### BACKGROUND

It is known in the electronics industry to use battery packs to store and subsequently supply energy to an electrical system. In traditional applications, batteries are either customized to particular applications, or multiple batteries are combined in a manner to provide the desired electrical characteristics. Typically, combining multiple batteries requires external connections, such as jumper tabs, soldered wiring, or welding. Commonly, battery assemblies are formed using automated processes that typically require a high level of control and repeatability, which also requires frequent calibration.

Battery systems may be used to provide power in a wide variety of applications. Examples of transportable applications include hybrid electric vehicles (HEV), plug-in HEVs, and electric vehicles (EV). Examples of stationary applications include backup power for telecommunications systems, uninterruptible power supplies (UPS), and distributed power generation applications.

Examples of the types of batteries that are used include nickel metal hydride (NiMH) batteries, lead-acid batteries, lithium batteries, lithium-ion batteries, and other types of batteries in a cylindrical form factor. A battery module includes a plurality of cells that are connected in series, parallel, or a combination thereof. The modules themselves may be connected in series, parallel, or a combination thereof in forming a complete battery pack.

Battery system integration poses multiple challenges in various disciplines. Most of the cost of a battery system lies with the battery cells. However, assembly defects, such as, for example, misaligned welds, can result in expensive recalls wherein there is no opportunity to reuse the cells. Also, in low cost manufacturing markets, which can be large producers and consumers of battery packs, battery systems are prone to quality issues as their manufacturing techniques rely heavily on manual assembly processes. An error-proof, manual assembly design that can easily be automated is key for successful production.

When fasteners are used to connect bus bars to battery cells, a large size battery pack can end up with thousands of fasteners, all which must be torqued down to the correct torque value with the risk of vibrations loosening a metal fastener that can cause a short.

Modules are often externally connected by bus bars or cables, with cables being a cheaper option. However, cables must be restrained to prevent loosening of the fasteners and chafing of the cables against other parts of the battery system. To restrain the cables at the lug terminal connecting it to the module, a two-hole lug terminal is commonly employed. To keep all modules the same, this requires all module-connecting bus bars to also have two holes, which doubles the amount of fasteners used in a battery pack and introduces added complexity to the bus bars used. The invention offers a built-in lug terminal restraint, saving the extra fastener.

Manufacturers of battery modules are always facing the dilemma of making small, highly configurable modules versus large, well-integrated modules. The smaller modules offer more packaging options and can meet more diverse market demands. But the larger modules are more highly integrated, increasing the overall power to mass/volume and energy to mass/volume ratios by, in part, reducing the number of fasteners, mounting brackets and cables or complex bus bars. Aside from constrained packaging, the other issue with large format modules is the cost of replacement since the entire module is typically replaced.

The present invention is directed to overcome one or more of the problems as set forth above.

### BRIEF SUMMARY OF THE INVENTION

In one aspect, the present disclosure provides a battery cell holder having a first side, a second side, a third side, fourth side, a top side and a bottom side. The battery cell holder can include a plurality of cell cavities configured to restrict the movement of a plurality of battery cells. The cell holder can include a plurality of flow passage configured to allow for the flow of air or a liquid to aid in cooling one or more battery cells or battery packs. A busbar locating member can be located on the surface of the cell holder. Additionally, the cell holder can include one or more horizontal mating members and one or more vertical mating members.

In another aspect, the present disclosure provides A battery cell holder having a first side, a second side, a third side, fourth side, a top surface and a bottom surface. The cell holder can include one or more cell cavity configured to restrict the movement of a battery cell. A plurality of flow passage can be positioned around and/or proximate to the cell cavity. A plurality of busbar locating members can be located on the top side of the cell holder, wherein the busbar locating members are configured to align a busbar on the top surface of the cell holder. A plurality of horizontal mating members located on one or more sides of the cell holder. The horizontal mating members can be configured to couple the cell holder to a second cell holder having a plurality of corresponding horizontal mating members along a horizontal plane. A plurality of vertical mating member located on the top surface and bottom surface can be configured to couple the cell holder along a vertical plane to a third cell holder having a plurality of corresponding vertical mating members.

The invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

FIG. 1 is an isometric view of a battery brick [1] showing parallel layer terminal [2], lug terminal restriction channel [3], dispenser [4], collector [5], flow entrance point [6], flow exit point [7] and brick-to-brick connecting peg hole [8].

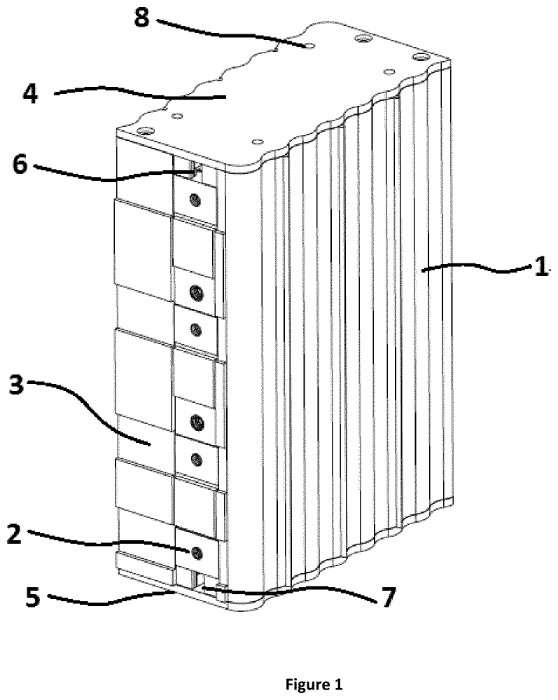

FIG. 2 is a top view of a dispenser [4] illustrates brick-to-brick connecting peg hole [8], brick-to-brick interlocking cavity [9], brick-to-brick interlocking pin [10] and plastic-to-plastic fastening hole [11].

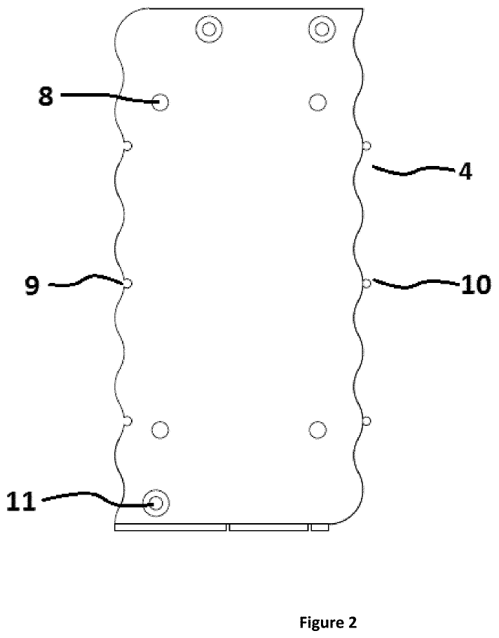

FIG. 3 is a front view of a battery brick [1] illustrates parallel layer terminal [2], lug terminal restriction channel [3], flow entrance point [6], flow exit point [7] and threaded spacer [26].

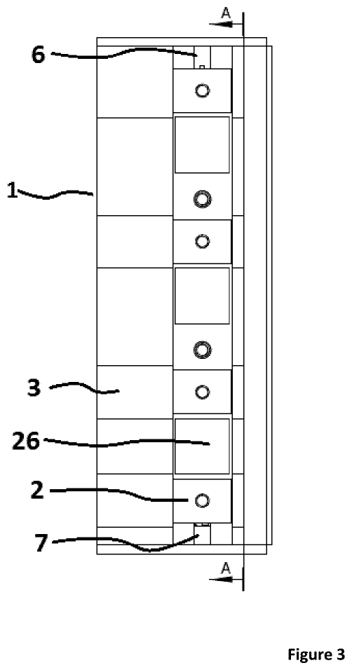

FIG. 4 is a cut-section A-A (shown in FIG. 3) illustrates lug terminal restriction channel [3], dispenser [4], collector [5], parallel layer of cells [12], battery cell [13], plastic holder [15] and bus bar [16].

FIG. 5 is an exploded view of a battery brick [1] illustrates dispenser [4], collector [5], battery cell [13], plastic holder [15] and bus bar [16] and external enclosure [17].

FIG. 6 is an isometric view of collector [5] illustrates flow exit point [7], brick-to-brick interlocking cavity [9], plastic-to-plastic fastening hole [11] and stepped cover [14].

FIG. 7 is a top view of collector [5] or bottom view of dispenser [4] illustrates manifold primary flow channel [21] and manifold secondary flow channel [22].

FIG. 8 is an isometric view of plastic holder [15] illustrates plastic-to-plastic fastening hole [11], flow passage through holder [18], sandwich locator [19] and cell cavity [20].

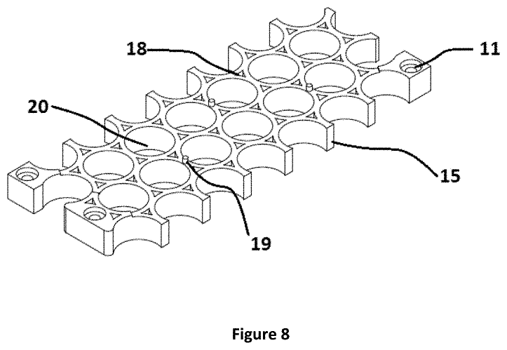

FIG. 9 is an isometric view of bus bar [16] illustrates parallel layer terminal [2], flow passage through bus bar [23] and sandwich locator hole [24].

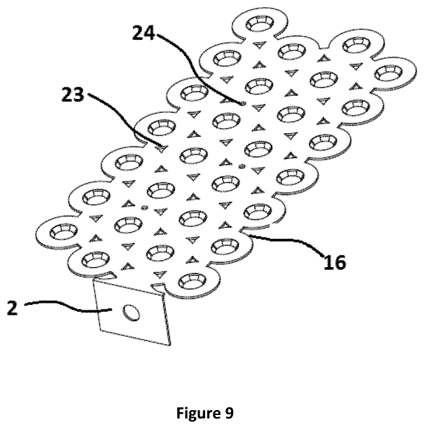

FIG. 10 is an isometric view of external enclosure [17] illustrates terminals slot [25].

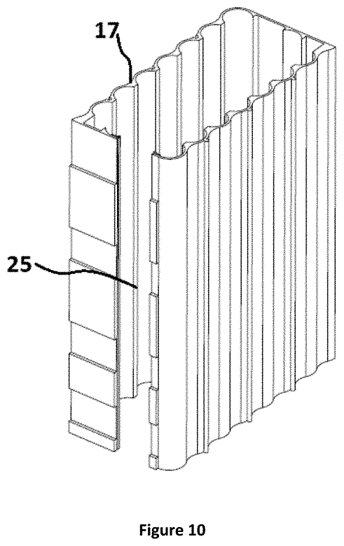

FIG. 11 is a top view of external enclosure [17] illustrates brick-to-brick interlocking cavity [9], brick-to-brick interlocking pin [10] and terminals slot [25].

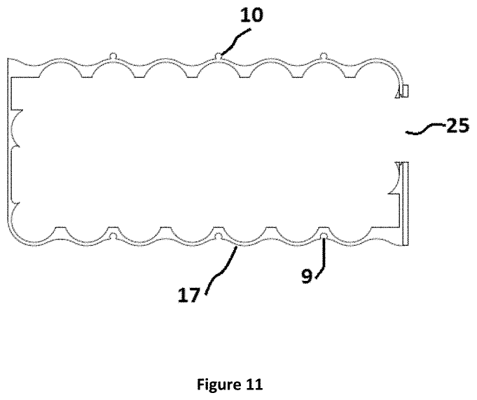

FIG. 12 is an isometric view of threaded spacer [26].

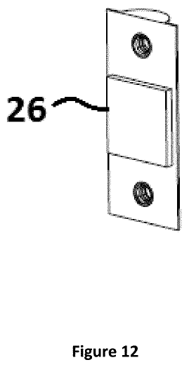

FIG. 13 is an isometric view of a battery module illustrating an assembly of bricks [1].

FIG. 14A is an isometric top view of cell holder [15] illustrates a plurality of horizontal mating members [51] and vertical mating members [53], flow passage [18] through holder, sandwich locator [19], cell cavity [20], and vertical spacer fixture cavity [55].

FIG. 14B is an isometric bottom view of cell holder [15] illustrates a plurality of horizontal mating members [51] and vertical mating members [53], flow passage [18] through holder, sandwich locator [19], cell cavity [20], and vertical spacer fixture cavity [55].

FIG. 15 is a top view of cell holder [15] illustrates a plurality of horizontal mating members [51] and vertical mating members [53], flow passage through holder [18], sandwich locator [19], cell cavity [20], and vertical spacer fixture cavity [55].

FIG. 16 is a side view of cell holder [15] illustrates a plurality of horizontal mating members [51] and vertical mating members [53], flow passage through holder [18], sandwich locator [19], cell cavity [20], and vertical spacer fixture cavity [55].

FIG. 17 is an isometric view of two cell holders [15a,b] illustrates a plurality of horizontal mating members [51] and vertical mating members [53], flow passage through holder [18], sandwich locator [19], cell cavity [20], and vertical spacer fixture cavity [55].

FIG. 18 is a top view of two cell holders [15] coupled together utilizing the horizontal mating members of the first cell holder [15a] and the second cell holder [15b] and having flow passage through holder [18], sandwich locator [19], cell cavity [20], and vertical spacer fixture cavity [55].

### DETAILED DESCRIPTION

The following detailed description includes references to the accompanying drawings, which forms a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, and logical changes may be made without departing from the scope of the present invention. The following detailed description is, therefore, not to be taken in a limiting sense.

Before the present invention of this disclosure is described in such detail, however, it is to be understood that this invention is not limited to particular variations set forth and may, of course, vary. Various changes may be made to the invention described and equivalents may be substituted without departing from the true spirit and scope of the invention. In addition, many modifications may be made to adapt a particular situation, material, composition of matter, process, process act(s) or step(s), to the objective(s), spirit or scope of the present invention. All such modifications are intended to be within the scope of the disclosure made herein.

Unless otherwise indicated, the words and phrases presented in this document have their ordinary meanings to one of skill in the art. Such ordinary meanings can be obtained by reference to their use in the art and by reference to general and scientific dictionaries.

References in the specification to “one embodiment” indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The following explanations of certain terms are meant to be illustrative rather than exhaustive. These terms have their ordinary meanings given by usage in the art and in addition include the following explanations.

As used herein, the term “and/or” refers to any one of the items, any combination of the items, or all of the items with which this term is associated.

As used herein, the singular forms “a,” “an,” and “the” include plural reference unless the context clearly dictates otherwise.

As used herein, the terms “include,” “for example,” “such as,” and the like are used illustratively and are not intended to limit the present invention.

As used herein, the terms “preferred” and “preferably” refer to embodiments of the invention that may afford certain benefits, under certain circumstances. However, other embodiments may also be preferred, under the same or other circumstances.

Furthermore, the recitation of one or more preferred embodiments does not imply that other embodiments are not useful and is not intended to exclude other embodiments from the scope of the invention.

As used herein, the terms “front,” “back,” “rear,” “upper,” “lower,” “right,” and “left” in this description are merely used to identify the various elements as they are oriented in the FIGS, with “front,” “back,” and “rear” being relative to the apparatus. These terms are not meant to limit the elements that they describe, as the various elements may be oriented differently in various applications.

As used herein, the term “coupled” means the joining of two members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate members being attached to one another. Such joining may be permanent in nature or alternatively may be removable or releasable in nature. Similarly, coupled can refer to a two member or elements being in communicatively coupled, wherein the two elements may be electronically, through various means, such as a metallic wire, wireless network, optical fiber, or other medium and methods.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure.

The present disclosure is directed to a battery module design that allows the complete manual assembly of the battery module from smaller battery sub-modules or bricks utilizing integral mating members that obviate the need for automated electrical and mechanical joining processes. Traditionally, automated processes have been perceived as having better quality control than manual assembly, but the battery module design disclosed herein achieves consistent quality of the final battery assembly with robust mechanical and electrical connections. The battery assembly does not require any welding or other high-accuracy automated processes. The invention does not require any welding or any high accuracy automated process. The battery module further comprises an integrated lug terminal restraint, thereby reducing the number of fasteners used in the final battery system.

Another direction of the present disclosure is related to a battery cell holder which can include first side, a second side, a third side, fourth side, a top side and a bottom side. The battery cell holder can additionally include one or more cell cavities configured to restrict the movement of one or more battery cells. The cell holder can additionally include a plurality of flow passage to allow for the movement of air or a cooling liquid. The cell holder can include a busbar locating member which in some embodiments can be configured to correspond to a busbar of a battery brick assembly. One or more horizontal mating members can be included on one or more sides of the cell holder. The horizontal mating members can be used to couple one or more cell holders along a horizontal plane. Similarly, one or more vertical mating members can be included on the top and bottom side of the cell holders. The vertical mating members can be used to couple one or more cell holders along a vertical plane. The vertical mating members can include any suitable means, including but not limited to a male pin member and a female aperture member. In some exemplary embodiments, the top surface of the cell holder can include a pin vertical mating member and the bottom surface of the cell holder can include a corresponding aperture vertical mating member to accept the pin mating member of a second cell holder. Alternatively, the vertical mating members can be switched between the top and bottom surface or other similar mating members can be utilized between a first cell holder and a second cell holder when coupling one more cell holders in a vertical plane.

The battery sub-module is a small-format, self-contained module, called a brick, that comprises the connection mechanism to the adjoining bricks. Bricks may be electrically connected in series or parallel using a flat, rectangular bus bar with minimum fasteners required. A battery module is then the assembly of multiple bricks, with power:mass, power:volume, energy:mass, energy:volume that are very similar to those of an individual brick.

Each brick is common design and construction as other bricks, wherein the only distinction is with respect to the battery module's bottom and top covers. The bottom cover secures the final negative busbar that is sandwiched by the bottom cover and a plastic spacer that secures the battery cells. A layer of cells is oriented in plastic spacer holes, and the battery brick is created by alternating subsequent spacer-busbar-spacer layers with additional battery cell layers. The top and bottom covers may be bonded to the external enclosure using adhesive.

Such a construction with alternating layers as described above facilitates direct manual assembly. The bottom and top of the plastic holders have matching pins and holes to lock the bus bar in place. Holes in the perimeter allow the use of hand-applied snap rivets to lock the two plastic holders together. Channels through the spacers and bus bars allow air flow paths for cooling or heating. The holders also contribute structural rigidity to the thin bus bar.

The busbars are connected to the cells by compression pressure that is applied through the layers from the top and bottom covers. One side of the bus bars has a spring to maintain contact with the positive terminals of the cells. Deflection of these springs is limited by plastic spacers that are located between the holders. The spacers also provide support for the bus bar tab for external connection and threads for the fastener used on that connection.

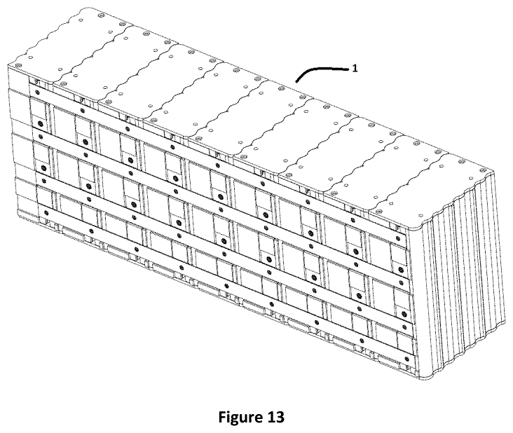

FIG. 13 illustrates a battery module is built from multiple battery bricks [1]. The bricks are mechanically interlocked to each other using interlocking pins [10] and cavities [9] on sides of the bricks. If an electrical parallel connection is required, all four parallel layer terminals [2] are connected between bricks via flat, rectangular bus bars that run through lug terminal restriction channels [3]. If an electrical series connection is required, bricks are connected through top and bottom parallel layer terminals only. In this aspect, the first brick will have cells oriented such that positive terminals are facing upward, the second brick will have cells oriented such that the negative terminals are facing upward, with subsequent layers alternating such that the positive and negative terminals of battery cells are mated to one another.

In an optional embodiment, if a cable connection is required to a different module or component, a single-hole lug terminal is used with a lug terminal width sized to fit in lug terminal restriction channel [3] to prevent it from rotating. In one embodiment, all parallel layer terminal connections utilize mechanical fasteners, such as for example bolts. In this embodiment, threads of the mechanical fasteners are mated into threaded holes in threaded spacer [26].

Bricks may also be assembled on top of each other. In this aspect, pegs are installed in brick-to-brick connecting peg holes [8] on top of dispenser [4] the collector [5] of the module on top has matching holes [8] to lock both modules together in a horizontal plane. The bottom brick is locked to a battery pack box by similar pegs located on a floor of the battery pack box. To prevent vertical movement, down pressure can be applied on the top brick by the battery pack box cover. The bricks can also be mounted on a side if matching interlocking features are used on the floor of the battery pack box.

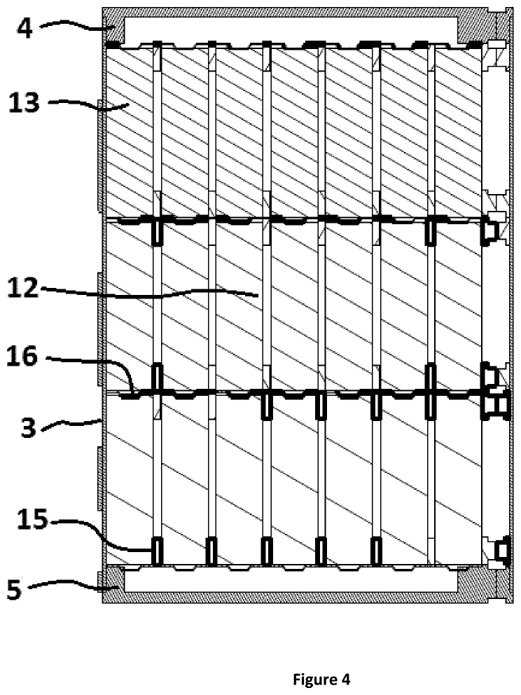

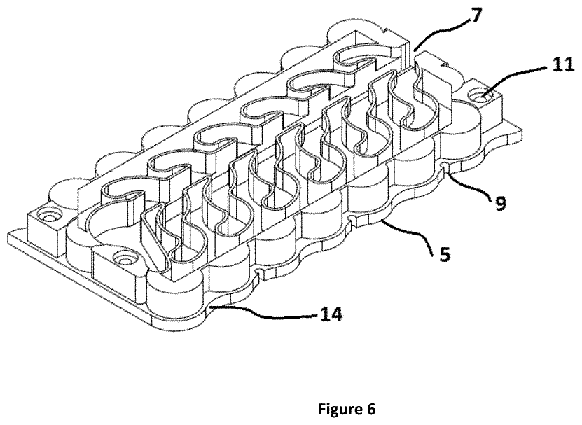

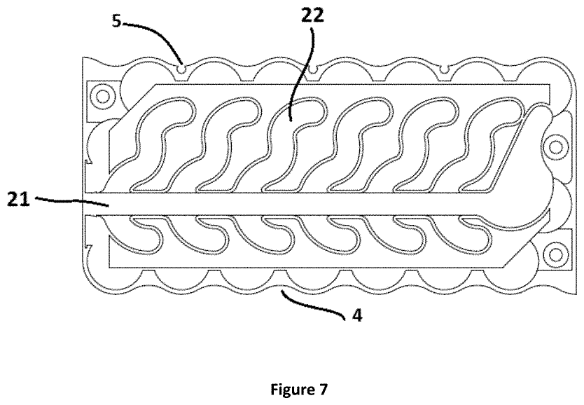

The top cover and bottom cover of the battery brick have the same internal design. The top cover is also used as dispenser [4], inlet manifold for the brick. A flow entrance point [6] allows a cooling medium to enter the battery module and flow through primary flow channel [21] where it splits to different secondary flow channels [22]. The secondary flow channels have different cross section to ensure equal pressure through all flow channels. The cooling medium then passes through bus bar flow passages [23] and through plastic holder flow passages [18]. The cooling medium continues to flow in parallel to a first layer of cells [12]. The cooling medium then passes through flow passages in a plastic holder-busbar-plastic holder sandwich, another layer of cells, another sandwich and another layer. At the bottom of a third layer, the cooling medium flows through the flow passages [23] in a lower-most busbar and collected at a cooling medium collector [5]. The bottom cover may also optionally be used as the cooling medium collector [5], in an exhaust manifold of the brick. The cooling medium may be collected through secondary flow channels [22] to the primary flow channel [21] and exits the cooling medium collector [5] at a flow exit point [7]. An exemplary cooling flow path is illustrated in FIGS. 4, 6 and 7.

A structure as disclosed herein with alternating layers of battery cells and busbars protects busbar [16] from damage, secures the cells [13] against the busbar terminals, and maintains a desired spacing distance between them. The spacing distance is necessary to prevent propagation of heat damage from one cell to the next. The bottom sandwich in the brick consists of layers of collector [5]-busbar [16]-plastic cell holder [15]. The top sandwich in the brick comprises layers of dispenser [4]-busbar [16]-plastic cell holder [15]. The internal layers comprise alternating layers of cell holder [15]-busbar [16]-cell holder [15]. The top of plastic structural parts may comprise locator pins [19], which go through locator holes in busbar [24] that ensure correct positioning. The bottom of the plastic parts further comprises locator holes that match the location of the locator pins. The pins are then positioned in the locator holes to finalize the positioning of the plastic components, the busbar, and the cells, which are then locked together using an external fastener, such as, for example, hand-applied plastic snap rivets through plastic-to-plastic fastening holes [11] in the plastic cell holders [15]. Similar to the fastening holes [11] one or more vertical mating members can be used to locate and couple one or more cell holders [15]. In some embodiments, the fastening holes [11] and vertical mating members are interchangeable.

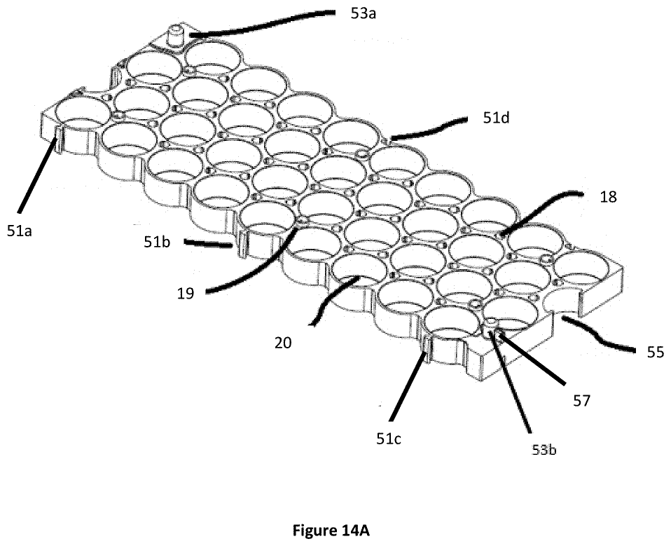

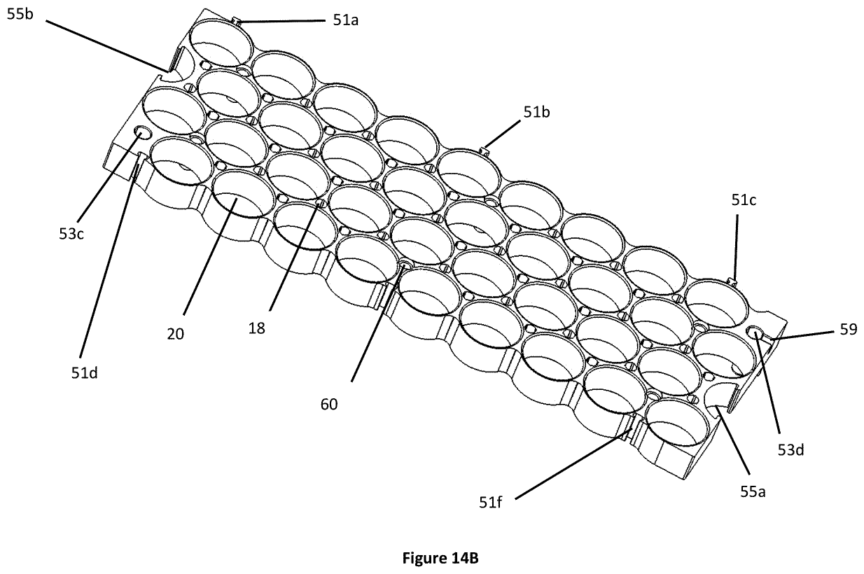

In some exemplary embodiments, a cell holder [15] of the present disclosure can be comprised of any suitable material, such as a plastic or polymer. As illustrated in FIG. 14A, a cell holder [15] be similar to external enclosure [17] that includes brick-to-brick interlocking cavity [9], brick-to-brick interlocking pin [10] and terminals slot [25], wherein each cell holder [15] can include on or more horizontal plane mating members [51a,b] and one or more vertical plane mating members [53a,b]. The cell holder can additionally include one or more comprise locator pins [19]. In some exemplary embodiments, the cell holder [15] can have a first horizontal mating member [51a] and a second horizontal mating member [51b]. A first horizontal mating member [51a] can be located on a first side of the cell holder [15] and a second horizontal mating member [51d] on a second side of the cell holder [15]. The horizontal mating members can be positioned across from one another on the corresponding sides of the cell holder [15]. In some exemplary embodiments, one or more of the vertical mating members [53] can additionally include a notch [57] extending perpendicular from the vertical mating member [53]. The notch [57] can be configured to interface with a corresponding vertical mating member [53] on the bottom of a second cell holder [15] and further restrict horizontal movement between the two cell holders [15]. In some exemplary embodiments, the vertical mating member [53] on the bottom of a second cell holder [15] can include a corresponding notch groove [59]. Cell holder [15] can have vertical mating members one or more or both of the top surface and bottom surface. FIG. 14A illustrates an exemplary embodiment of the present disclosure, wherein a top surface of a cell holder [15] wherein the vertical mating members [53] can extend perpendicularly from the top surface of the in the form of a pin member. The bottom side of a cell holder [15] can include a corresponding vertical mating member [53] to correspond to the vertical mating member on the top side of a second cell holder [15].

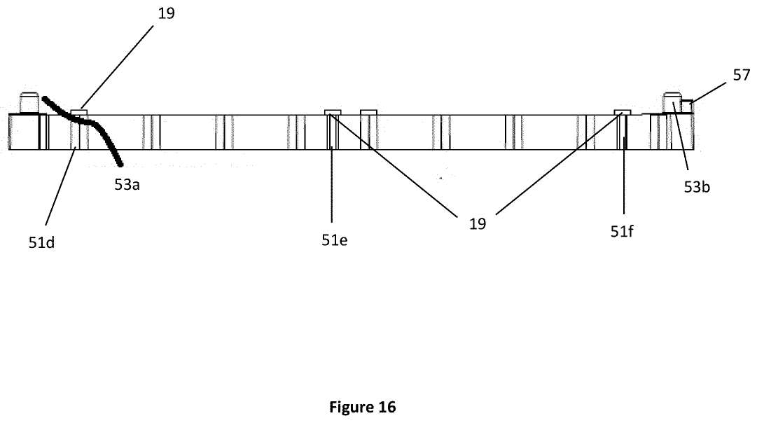

As shown in FIG. 14B the bottom surface of a cell holder [15] can include a corresponding vertical mating member [53]. In some exemplary embodiments, a first surface of the cell holder [15] can include a vertical mating member [53] and the second surface of the cell holder [15] can include a corresponding vertical mating member. As shown in FIGS. 14A-B, one exemplary embodiment of the present disclosure can include corresponding vertical mating members on either surface of the cell holder [15] wherein a first vertical mating member can be in the form of one or more a pin member [53a,b] shown in FIG. 14A. A corresponding vertical mating member on a second surface can be an aperture [53c,d] for capturing the pin member of a second cell holder [15]. In some embodiments, the bottom surface can also include an aperture [60] for the sandwich locator located on the surface of a second cell holder [15]. The vertical mating members [53] that take the form of a pin can extend perpendicularly from the surface of a cell holder [15] similar to the sandwich locator [19]. The vertical mating member pins can extend a greater distance from the surface of the cell holder [15] than the sandwich locators [19] as shown in FIG. 16.

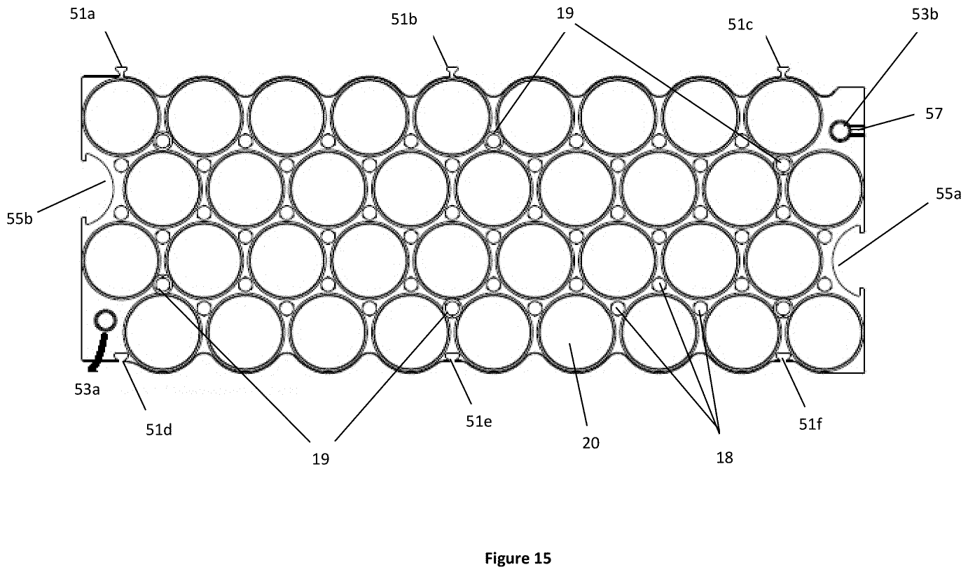

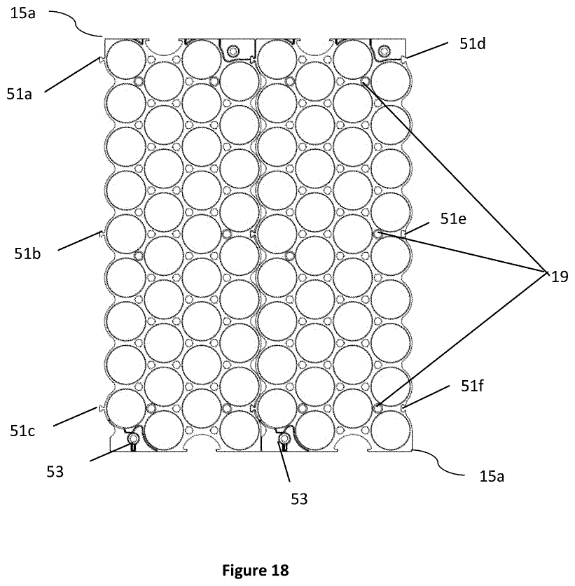

In some exemplary embodiments, the first horizontal mating member can be a male protruding mating member extending out from the first side of the cell holder [15]. A second horizontal mating member can be a female groove member configured accept a first horizontal mating member from a second cell holder [15] as shown in FIG. 18. Some exemplary embodiments of the present disclosure as shown in FIG. 15, each cell holder can have a plurality of horizontal mating members [51a,b,c] on a first side of the cell holder [15] and plurality of horizontal mating members [51d,e,f] on a second side of the cell holder [15]. Additionally, the third and fourth side can include one or more vertical space fixture cavities [55a,b].

As shown in FIGS. 14-18, the cell holder [15] can further include one or more locator pins [19], which are configured to correspond to locator holes [24] in busbar [16] that ensure correct positioning of the busbar [16]. In some exemplary embodiments, the cell holder [15] can further include a vertical space fixture cavity [55]. A fixture cavity can be formed on either or both ends of the cell holder [15] as shown in FIG. 15. The vertical spacer fixture cavity [55] can be configured to allow for easier access to the parallel layer terminal [2] of the busbar when communicatively coupling one or more battery bricks or layers of a battery brick. Similarly, the vertical space fixture cavity [55] can correspond to the terminal slot [25] of the external enclosure [17] to allow for a treaded spacer [26] and or the parallel layer terminal [2].

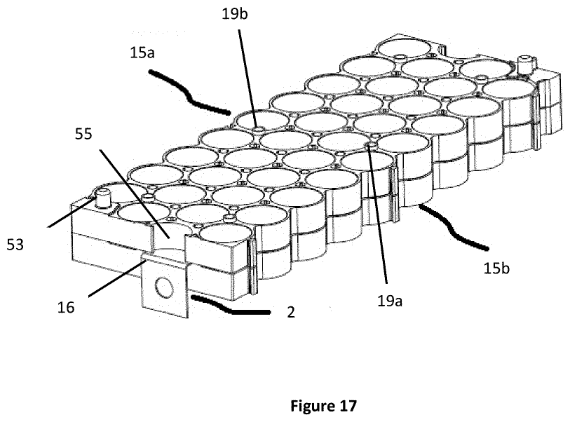

As shown in FIG. 17, the vertical mating members [53] can be used to couple a first cell holder [15a] and a second cell holder [15b] in a vertical relationship and can allow for a number of battery cells to be held and connected in parallel. In some exemplary embodiments, a busbar [16] can be positioned between the first and second cell holders [15]. Similarly, the cell holder [15] can be used to mechanically mate layer of battery cells to form a battery brick assembly. FIG. 18 illustrates a first cell holder [15a] and a second cell holder [15b] coupled together on a horizontal plane using at least one first horizontal mating member of a first cell holder and a first horizontal mating member of a second cell holder. In some embodiments, the cell holders can operate as mechanical mating members configured to restrict movement of battery cells within the cell cavities. Additionally, the cell holders can also operate as mechanical mating members to couple one or more battery brick assemblies to one another as shown in FIG. 13.

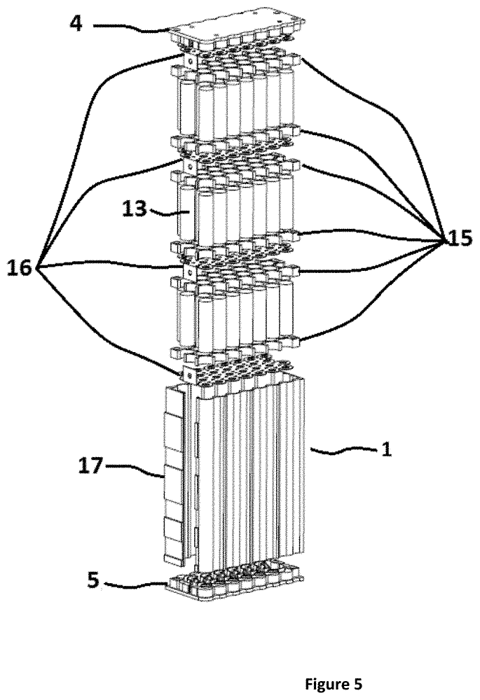

The assembly of brick [1] is best illustrated by FIG. 5. The bottom sandwich described above is the base of the brick. External enclosure [17] is bonded to stepped bottom cover [14]. Cells [13] are installed in each cavity of cell holder [15] to create a parallel layer [12]. A threaded spacer [26] slides through a terminal slot. Another spacer slides onto a second end of brick [1] to fill a gap between cells [13] and an external enclosure [17]. Spacers [26] limit deflection of busbar cell tabs, ensuring the weight of the cells from layers above does not apply stress on a given layer. Threaded spacers [26] on slot side [25] receive the fasteners used to connect external bus bars or lug terminals to the parallel layers' terminals [2]. An internal sandwich installed on top of the cells' layer [12] where parallel layer terminal [2] slides through a terminal slot [25]. A second set of spacers [26] may also be installed. A second layer of cells may be installed with a second internal sandwich proximate thereto. Further, a third layer of cells [13] and spacers [26] are installed with a top sandwich closing the brick. Stepped top cover [14] is bonded to the external enclosure supplying necessary pressure on the internal parts to create a required mechanical contact of cells and bus bars. If a cell is misaligned or a contamination exists between the layers, a gap will exist between the top cover and the external enclosure. The gap is a sign for a defect in assembly.

As shown in FIG. 17, a plurality of cell holders can be coupled together utilizing the vertical mating members [55]. In some exemplary embodiments, as shown in FIG. 18, one or more cell holders [15a,b] can be mated together along a horizontal plane using one or more of the horizontal mating members [51] of the respective cell holders [15a,b].

One exemplary embodiment of a cell holder [15] of the present disclosure can include a first side having one or more horizontal mating members [51a,b,c] and a second side having one or more corresponding horizontal mating members [51d,e,f]. In some embodiments, the first side of horizontal mating members [51a,b,c] can be formed as a pin. The pin can take any form, such as a t-shape pin having one or more additional extension extending perpendicularly from the end of the pin. The mating members [51d,e,f] on the second side can include a recess or corresponding aperture to accept the shape of the pin on the first side of the cell holder [15]. This can allow for multiple cell holder [15] to be coupled together along a horizontal plane. The third side can have a vertical spacer fixture cavity [55a]. In some embodiment, a fourth side can also include a vertical spacer fixture cavity [55b]. The top surface/side of the cell holder can include one or more sandwich locator pins [19] that can be used to locate a busbar 16 onto the cell holder [15].

A surface of the cell holder [15] can have one or more sandwich locators [19]. As shown in FIG. 16, some exemplary embodiments can have six sandwich locators [19]. IN some embodiments, the cell holder may include at least two sandwich locators [19], wherein one sandwich locator [19a] is proximate to a first side of the cell holder [15] and the second sandwich locator [19] is proximate to a second side of the cell holder [15]. The cell holder [15] can additionally include a plurality of cell cavities [20] for holding a battery cell. The cell cavities [20] can be surrounded by one or more flow passages [18]. The flow passages can allow for the movement of a liquid or air to occur between the cells to allow for better cooling of the battery cells and battery packs.

Additionally, the top surface can include one or more vertical mating members [53a,b]. The vertical mating member [53] can be located in any suitable position. In some exemplary embodiments, the cell holder [15] can have a vertical mating member [53a] on proximate to the third side on the top surface of the cell holder [15]. Optionally, a second vertical mating member [53b] can be located proximate to the fourth side on the top surface of the cell holder [15]. The cell holder [15] can additionally include one or more corresponding vertical mating members [53] on the bottom surface/side of the cell holder [15]. As shown in FIG. 14B, the bottom surface can have a corresponding vertical mating member [53c,d]. The vertical mating members can take any suitable form, include a pin and aperture form shown in the illustrations. In some exemplary embodiments, one or more vertical mating members [53] may additionally include a notch [57] that extends perpendicularly from the surface of the vertical mating member pin as shown in FIG. 16.

Battery bricks may be mated together side by side by interlocking sliders on along their length. The flat bus bars connecting each layer supply more structural rigidity.

The horizontal and vertical mating members can be similar to the mechanical mating members of the bottom and top cover.

The module may be entirely hand-assembled with fasteners used only for external connections and no welds needed. Adhesive is only applied between plastic pieces without special, highly conductive or high temperature adhesive is needed.

The module may be expanded as needed for practically unlimited parallel and series configurations. New layers can be added to increase the number of series elements, new bricks can be attached side-by-side to increase the number of parallel or series elements.

If the module design of the present disclosure were to be used in a system design including liquid cooling, the liquid cooling medium must be electrically insulating as it touches the bus bars.

When cooling a battery module, added structure or material is needed to support the cooling media. The bricks are designed to integrate cooling flow channels and manifolds, reducing the need for additional elements in the module design. Each brick has its own cooling medium inlet and outlet, and the overall module system may incorporate manifolds to dispense the air flow to various bricks.

If sealing is needed, the greatest leak-potential points are parallel layer terminals. A rubber seal ring can be applied around the busbar section leading to these terminals. Adhesive seal can be applied along the terminal's slot.

The plastic structure is used for electrical isolation and creates thermal insulation, thereby inhibiting the propagation of thermal events. Highly thermally conductive plastic may be used. The external enclosure may be made of metal such as aluminum.

If a more integrated design is required and the packaging of the pack allows, a brick design can easily be modified to include all parallel elements in a single brick. The number of series elements, i.e. layers, is limited by the height limit of the pack and the pressure required to push the cooling media through the layers. Theoretically the entire pack can be assembled into a single brick.

While the invention has been described above in terms of specific embodiments, it is to be understood that the invention is not limited to these disclosed embodiments. Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

### LIST OF ELEMENTS

[1] battery brick
[2] parallel layer terminal
[3] lug terminal restriction channel
[4] dispenser
[5] collector
[6] flow entrance point
[7] flow exit point
[8] brick-to-brick connecting peg hole
[9] brick-to-brick interlocking cavity
[10] brick-to-brick interlocking pin
[11] plastic-to-plastic fastening hole
[12] parallel layer of cells
[13] battery cell
[14] stepped cover
[15] plastic holder
[16] busbar
[17] external enclosure
[18] flow passage through holder
[19] sandwich locator
[20] cell cavity
[21] manifold primary flow channel
[22] manifold secondary flow channel
[23] flow passage through bus bar
[24] sandwich locator hole
[25] terminals slot
[26] threaded spacer
[51] horizontal mating member
[53] vertical mating member
   [55] vertical spacer fixture cavity
   [57] notch member
   [59] notch aperture
   [60] sandwich locator aperture

What is claimed is:

1. A battery cell holder, comprising:
a first side, a second side, a third side, fourth side, a top side and a bottom side;
a plurality of cell cavities configured to restrict the movement of a plurality of battery cells;
a plurality of flow passage;
a busbar locating member;
a horizontal mating member; and
a vertical mating member.

2. The battery cell holder of claim 1, further comprising:
a vertical spacer fixture cavity.

3. The battery cell holder of claim 2, wherein the vertical spacer fixture cavity is configured to allow for access to a parallel layer terminal of a busbar.

4. The battery cell holder of claim 3, wherein the battery cell holder comprises a first horizontal mating member on the first side and a second horizontal mating member on the second side of the battery cell holder.

5. The battery cell holder of claim 4, wherein the first and second horizontal mating members are configured to form horizontal coupling means between one or more battery cell holders.

6. The battery cell holder of claim 5, wherein the battery cell holder comprises a first vertical mating member on the top side and a second vertical mating member on the bottom side.

7. The battery cell holder of claim 6, wherein the first and second vertical mating members are configured to form vertical coupling means between one or more battery cell holders.

8. The battery cell holder of claim 7, wherein the first horizontal mating member is configured to couple to a second horizontal mating member on a second side of a second battery cell holder.

9. The battery cell holder of claim 8, wherein the first horizontal matting member is an interlocking pin, and the second horizontal mating member is a slot configured to accept a corresponding interlocking pin from the second battery cell holder.

10. The battery cell holder of claim 9, wherein the vertical mating member further comprises a notch to correspond to a vertical mating member of a second cell holder, wherein the notch is configured to further reduce horizontal movement between the cell holder and the second cell holder.

11. A battery cell holder, comprising:
a first side, a second side, a third side, fourth side, a top surface and a bottom surface;
a cell cavity configured to restrict the movement of a battery cell;
a plurality of flow passage proximate to the cell cavity;
a plurality of busbar locating members on the top side of the cell holder, wherein the busbar locating members are configured to align a busbar on the top surface of the cell holder;
a plurality of horizontal mating members located on one or more sides of the cell holder, wherein the horizontal mating members are configured to couple the cell holder to a second cell holder having a plurality of corresponding horizontal mating members, wherein the cell holder and second cell holder are coupled along a horizontal plane; and
a plurality of vertical mating member located on the top surface and bottom surface, wherein the vertical mating members are configured to couple the cell holder to a third cell holder having a plurality of corresponding vertical mating members, wherein the cell holder and second cell holder are coupled along a vertical plane.

12. The battery cell holder of claim 11, further comprising:
a vertical spacer fixture cavity.

13. The battery cell holder of claim 12, wherein the vertical spacer fixture cavity is configured to allow for access to a parallel layer terminal of a busbar.

14. The battery cell holder of claim 13, wherein the battery cell holder comprises a first horizontal mating member on the first side and a second horizontal mating member on the second side of the battery cell holder.

15. The battery cell holder of claim 14, wherein the first and second horizontal mating members are configured to form horizontal coupling means between one or more battery cell holders.

16. The battery cell holder of claim 15, wherein the battery cell holder comprises a first vertical mating member on the top side and a second vertical mating member on the bottom side.

17. The battery cell holder of claim 16, wherein the first and second vertical mating members are configured to form vertical coupling means between one or more battery cell holders.
